(19) United States
(12) Patent Application Publication
(10) Pub. No.: US 2010/0297980 A1
(43) Pub. Date: Nov. 25, 2010

(54) Method and Apparatus for Transmission of Emergency Messages

(76) Inventors: William Alberth, Prairie Grove, IL (US); Wayne W. Ballantyne, Plantation, FL (US); Stuart S. Kreitzer, Coral Springs, FL (US)

Correspondence Address: PHILIP H. BURRUS, IV, 460 Grant Street, Atlanta, GA, 30312, US

(21) Appl. No.: 12/468,701

(22) Filed: May 19, 2009

(51) Int. Cl. H04M 11/04

(52) U.S. Cl. 455/404.2

(57) ABSTRACT

An emergency text message application (205), operable to control a processor (201) in a portable electronic device (200) is provided. The emergency text message application (205) allows a user to send any of a manually input, partially completed, or preformed completed emergency text message to emergency services personnel. A location detection module (204) can be used to retrieve a location of the portable electronic device (200). The emergency text message application (205) can then insert the location into the emergency text message. As more accurate location determinations are made, the emergency text message application (205) can substitute the more accurate information into the emergency text message and retransmit. An alert disabler can automatically transform the portable electronic device (200) to a vibration mode or silent mode to prevent incoming communication from being audible to a nearby threat.

### CROSS REFERENCE TO RELATED APPLICATIONS

This application is related of U.S. application Ser. No. ______, entitled “Method and Apparatus for Transmission of Emergency Messages, filed ______, attorney docket number CS36862, by common inventors and a common assignee.

### BACKGROUND

1. Technical Field

The present invention relates generally to the transmission of messages from mobile communication devices, and more specifically, to a method and apparatus, as well as configurations for the apparatus, used for transmitting emergency messages to an emergency services call number in response to an emergency situation.

2. Background Art

Mobile communication devices, such as mobile telephones, personal digital assistants, and palm-top computers, have become important tools for daily communication. Once a novelty, these devices have practically become a necessity in today's world. These devices allow people to stay in contact with friends, family, and co-workers regardless of location.

While these devices bring added convenience in normal everyday life, they can become life-saving tools in the event of an emergency. Anecdotal evidence taken from emergency services personnel responding to national disasters suggests that the three most useful tools in an emergency are a pocketknife, flashlight, and a mobile communication device. When a person encounters an emergency, be it an automobile accident, a fire, a tornado, a hurricane, a home invasion, a business robbery, or a terrorist attack, the person can use a mobile device to call for help. The user generally does this by dialing E911. An operator then answers the call, asks the caller to describe the emergency, and then dispatches emergency personnel, who rush to the user to provide appropriate help.

There are some situations, however, where calling 911 is a less than ideal solution. Turning now to FIG. 1, illustrated therein is just such an emergency situation 100. As shown in FIG. 1, a store clerk 101 is being held at gunpoint by a crook 102 who is attempting to take money 103 from the cash register 104. Initially undetected by the crook 102, a store patron 105 is hiding between aisles 106 of goods. The store patron 105 has a mobile communication device 107, which in this case is a mobile telephone. The mobile communication device 107 is of little use, however, because if the store patron 105 attempts to call 911, the crook 102 may overhear the call, thereby discovering the store patron 105. As such, a call to 911 may put the store patron's safety, as well as the clerk's safety, in jeopardy.

A store patron 105 in such a situation may attempt to use alternate communication means to contact the emergency personnel. For example, the store patron 105 may attempt to transmit an electronic mail or text message to the emergency services call number. However, this approach can be time consuming and cumbersome.

There is thus a need for an improved method and apparatus for transmitting emergency messages to emergency personnel.

### BRIEF DESCRIPTION OF THE DRAWINGS

FIG. 1 illustrates an emergency situation with a store patron attempting to communicate with emergency personnel via a prior art mobile communication device.

FIG. 2 illustrates one portable electronic device in accordance with embodiments of the invention.

FIG. 3 illustrates one method suitable for use with a portable electronic device in accordance with embodiments of the invention.

FIG. 4 illustrates one method suitable for use with a portable electronic device in accordance with embodiments of the invention.

FIG. 5 illustrates one exemplary screen shot in a text messaging application operating on a portable electronic device in accordance with embodiments of the invention.

FIG. 6 illustrates one exemplary screen shot in a text messaging application operating on a portable electronic device in accordance with embodiments of the invention.

FIG. 7 illustrates one exemplary screen shot in a text messaging application operating on a portable electronic device in accordance with embodiments of the invention.

FIG. 8 illustrates one exemplary screen shot in a text messaging application operating on a portable electronic device in accordance with embodiments of the invention.

FIG. 9 illustrates the emergency situation of FIG. 1, however, the store patron is equipped with an exemplary portable electronic device configured in accordance with embodiments of the invention.

FIG. 10 illustrates another portable electronic device in accordance with embodiments of the invention.

FIG. 11 illustrates another method suitable for use in a portable electronic device configured in accordance with embodiments of the invention.

FIG. 12 illustrates one situational application illustrating operation of a portable electronic device configured in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to transmission of emergency messages to emergency personnel. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of transmitting emergency messages as described herein. The non-processor circuits may include, but are not limited to, a radio receiver, a radio transmitter, signal drivers, clock circuits, power source circuits, and user input devices. As such, these functions may be interpreted as steps of a method to perform transmission of emergency messages. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide an improved method and apparatus for transmitting emergency text messages to emergency personnel. In one embodiment of the invention, upon detecting an emergency situation, a portable electronic device such as a mobile telephone, a smart phone, a pager, a personal digital assistant, or a palm-top computer, presents a selection of preformed emergency text message to a user. For example, the message may read, “I am being robbed.” Alternatively, the preformed emergency text message may be a partially completed message, such as “______ is being robbed,” where the user's name is automatically inserted into the blank. The user is then able to select one of the emergency text messages for transmission to emergency personnel. If the message is fully completed, the user simply sends the message. If the message is partially completed, the user's identity or other information may be automatically inserted into one or more fields. As an option, the user may be able to populate a few fields, in one embodiment with the assistance of pull-down menus, and then transmit the message to the emergency services number. This improvement permits a user to transmit an emergency text message without having to tediously input every character of every sentence while in a stressful situation.

In one embodiment of the invention, the portable electronic device is configured to automatically insert a location of the portable electronic device prior to sending the emergency message to the emergency services number. This feature eliminates the need for the user to manually input his location. In one embodiment of the invention, the portable electronic device is configured to progressively obtain more accurate location information and to re-transmit the emergency message with updated, and more accurate, location information. This feature allows emergency personnel to obtain better and better approximations of the user's location without the need for the user to repeatedly enter information into the device.

Portable electronic devices in accordance with the invention can be configured with additional features as well. For example, in one embodiment, the portable electronic device is configured to transform its operational mode from one having audible alerts to either a silent mode or a vibration mode. In so doing, people about the user—including those who may be capable of doing harm to the user—will not be alerted if emergency personnel or other parties try to communicate with the user. In another embodiment, distress messaging can be inserted into the emergency message. By way of example, the words “Threat is present—please do not respond by text or voice call” may be added to an emergency message prior to transmission.

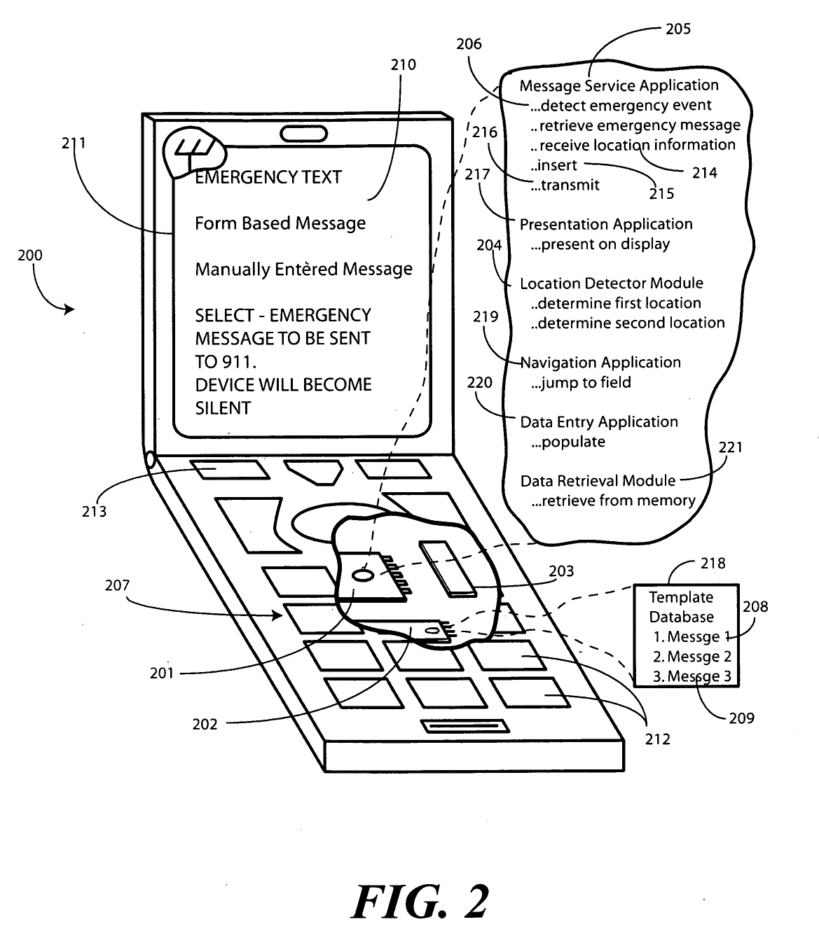

Turning now to FIG. 2, illustrated therein is one embodiment of a portable electronic device 200 in accordance with embodiments of the invention. The portable electronic device 200 of FIG. 2, as well as those shown in subsequent figures, is that of a mobile telephone. This device is used for simplicity of discussion. However, it will be clear to those of ordinary skill in the art having the benefit of this disclosure that the invention is not so limited. Embodiments of the invention may be equally applied to other portable electronic communication devices, such as personal digital assistants, radios, portable computers, and so forth.

The portable electronic device 200 of FIG. 2 includes a processor 201 and a corresponding memory 202. In one embodiment, a microcontroller is used as the processor 201. Such microcontrollers are capable of executing embedded code stored in the memory 202. While microcontrollers are used in one embodiment as the processor 201 due to the relatively low cost and high degree of configurability, other devices capable of executing a programmed instruction set may also be employed. The associated memory 202, which may include both static and dynamic memory components, may be used for storing both embedded code for the processor and user data.

A communication circuit 203 is used to facilitate electronic communication with remote devices. The communication circuit 203, which may be one of a receiver or transmitter, and may alternatively be a transceiver, operates in conjunction with the processor 201 to electronically transmit messages through a predetermined communication network. Examples of such communication networks include, for example, Wi-Fi, Code Division Multiple Access (CDMA), Time Division Multiple Access (TDMA), Global System for Mobile communication (GSM), a Push-to-Talk (PTT), proprietary, direct communication, and IEEE 802.11 networks. The communication circuit 203 is configured, in one embodiment, for communication with wide area networks. In another embodiment, the communication circuit 203 is configured for communication with local area networks. In another embodiment, both wide area and local area networks are accommodated. Note that it is possible to combine the processor 201, the memory 202, and the communication device 203 into a single device or into devices having fewer parts while retaining the functionality of the constituent parts.

A location determination module 204, which may be configured as embedded code operable with the processor 201 and the communication circuit 203, is configured to determine the approximate location of the portable electronic device 200. As will be described in more detail below, the location determination module 204 can detect location in a variety of ways. For example, the location determination module 204 can determine the location of the portable electronic device 200 by detecting the identifier or location of the last-used base station. This would give a location with an accuracy of between a one and twenty kilometer radius.

The location determination module 204 can also determine the location of the portable electronic device 200 by triangulation. Triangulation, such as Advanced Forward Link Triangulation (AFLT), is well known in the art. Triangulation is the process of determining where a portable electronic device is located between three or more base stations. It can be accomplished by measuring either the radial distance, the signal strength, or the direction, of received signals from a portable electronic device from two or three base stations. Triangulation generally provides a more accurate approximation of location that, for example, the location of a last-used base station.

The location determination module 204 can determine location with other triangulation techniques, such as by Enhanced Observed Time Difference (EOTD). EOTD, known in the art, is a method of determining location where the portable electronic device 200 receives bursts of data received from base stations. The portable electronic device 200 then records the burst arrival times. The location of the portable electronic device can then be determined by triangulation using the location coordinates of each base station transmitting bursts, the arrival time of each burst, and the timing differences between bursts from each base station.

The location determination module 204 can also determine location of the portable electronic device by other means, such as with the assistance of location determination hardware. One example of location determination hardware would be a Global Positioning System (GPS) receiver disposed in the portable electronic device 200 that is operable with processor 201 and with GPS satellites. For example, in one embodiment location determination is carried out with the location determination module working in tandem with network procedures and accompanying location determination hardware.

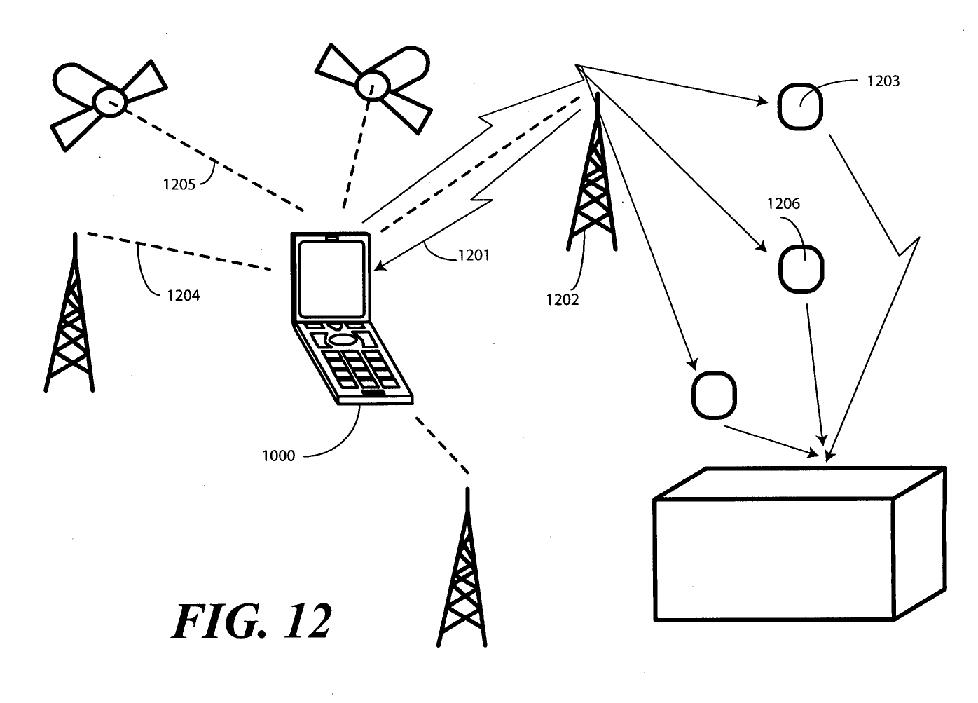

In one embodiment, the location determination module 204 is configured to first quickly determine a rough approximation of location, such as the identifier of the last-used base station. This may be done where more accurate location information is not immediately available. An emergency message can then be transmitted. Later, the location determination module 204 can determine a more accurate measurement of location and can retransmit the emergency message with updated location information. This will be described in more detail below in the discussion of FIGS. 12 and 13.

An emergency text message application 205 is operable with the processor 201 for sending emergency text messages to emergency service personnel through emergency services call numbers. Alternatively, Uniform Resource Identifiers (URIs) may be used to transmit the emergency text message to the emergency service personnel. The emergency text message application 205 can also be configured for receiving asynchronous messages as well. In one embodiment, the emergency text message application 205 is configured as embedded firmware code that is operable with the processor 201. In such an embodiment, the emergency text message application 205 includes a set of instructions for the processor 201 to execute the steps of creating, presenting, storing, sending, and receiving emergency text messages. Alternatively, the emergency text message application 205 can be configured in hardware, such as through programmable logic devices. As will be described in more detail below, the emergency text message application 205 of the present invention can expedite the message creation process by presenting partially or fully completed messages to the user.

In one embodiment, the emergency text message application 205 is configured to detect 206 an emergency event. This can be done in a variety of ways. First, a user may indicate that an emergency situation or event is occurring through the user interface 207. There may be a special key or combination of keys that a user may employ to indicate an emergency. Alternatively, a key may be held down for a predetermined amount of time. Other mechanisms for a user to alert the portable electronic device 200 that an emergency event is occurring will be clear to those of ordinary skill in the art having the benefit of this disclosure as well.

Alternatively, the emergency text message application 205 may detect 206 an emergency event automatically. For example, the portable electronic device 200 may include an environmental sensor, such as a smoke detection circuit or temperature detection circuit that is configured to detect an emergency situation such as fire. Alternatively, the portable electronic device 200 may include a biometric sensor, such as a heart rate monitor, to detect when the user is under extreme stress. Such stress may be in response to the user being involved in an emergency situation.

Regardless of detection means, upon determining that an emergency situation is occurring, in one embodiment the emergency text message application 205 is configured to retrieve either a partially completed emergency text message 208, a fully completed emergency text message 209, or combinations thereof, from the memory 202. Once this retrieved emergency text message is obtained from memory, the emergency text message application 205 can be configured to present the retrieved emergency text message 210 on the display 211 of the portable electronic device 200.

In one embodiment, for speed of use, the retrieved emergency text message 210 is a fully populated message 209. Examples of fully populated messages 209 include, “I am being followed and feel threatened,” “I am being robbed,” “I am being kidnapped,” “Robbery at my location in progress,” “Home invasion in progress,” “I am witnessing a violent crime,” “Personal medical emergency—I cannot speak,” and “I am in a fire and need help.” Fully populated messages 209 are extremely useful in emergency situations in that the user need only hit a button or two to send a completed message. There is not the need to tediously input text.

Where the retrieved emergency text message 210 is a partially completed emergency text message 208, in one embodiment, the emergency text message application 205 is configured to automatically populate the missing information. For instance, in one embodiment the user is able to store identification information, such as name, telephone number, and address, in an identification file in the memory 202 of the portable electronic device 200. A partially completed emergency text message 208 might read, “______ is having a heart attack.” The emergency text message application 205 can then automatically populate the “______” with the user's name. As with the fully populated message 209, there is not the need to tediously input text.

In an optional alternative embodiment, the partially completed emergency text message 208 can include user fillable fields to be completed by the user. For example, one user fillable field may be the user's name. In one embodiment, the user may enter information to populate the user fillable field with the user interface 207. In another embodiment, the user fillable field may be presented with a set of tab-accessible fields disposed therein. To complete a message, the user may simply jump to a tab-accessible field, complete the field with the user interface 207, and then send the message to the emergency personnel. For example, if a person wanted to send an emergency text message saying “______ is having a heart attack” with the “______” being a tab-accessible field, the user would only need to enter the name, rather than constructing the entire message multiple times. The user could simply enter “George Burdell” in the tab-accessible field and then send the message.

As noted above, the portable electronic device 200 includes a user interface 207 with which the user may enter data. In one embodiment, such as where tab-accessible fields are used, the user interface 207 can include at least one data entry key 212 and at least one tab key 213. The data entry key 212 may be one key of a 12-digit numeric keypad, with number keys corresponding to a plurality of letters. The tab key 213 may be either a dedicated key or a “soft key.” A soft key is a key beneath the display 211 where the soft key's function changes depending upon the particular display. For example, when the portable electronic device 200 has detected an emergency and is in emergency mode, a single soft key may operate as a “send message” key, while the same soft key may operate as a “select emergency message” key when retrieved emergency text messages 210 are presented on the display 211. The function associated with each soft key can be presented on the display 211.

Regardless of whether the emergency text message application 205 presents partially completed emergency text messages 208 or fully completed emergency text messages 209 on the display 211, the resulting message will be transmitted to an emergency services call number via the communication circuit 203. Prior to doing so, however, in one embodiment the emergency text message application 205 is configured to automatically retrieve 214 the location of the portable electronic device 200 from the location determination module 204 and to automatically insert 215 the location into the resulting message to form a completed message. The emergency text message application 205 can then transmit 216 the emergency text message to an emergency services call number, such as E911, via the communication circuit 203.

The illustrative portable electronic device 200 of FIG. 2 can function in a variety of ways to transmit emergency text messages to emergency personnel. For example, in one embodiment a menu of preformed emergency text messages can be presented on the display 211. The emergency text message application 205 can then, via the location determination module 204, insert the location of the portable electronic device 200 into the emergency text message automatically. In one embodiment, the location determination module 204 determines an initial location, such as a base station identifier, to insert into the emergency text message. This provides a quick, initial emergency text message that can be sent to emergency personnel. The location determination module 204 can then determine a more accurate location, such as via coordinates received from GPS satellites. The emergency text message application 205 can then transmit an updated emergency text message with updated—and more accurate—location information. In one embodiment, the emergency text message application 205 amends the header of the emergency text message to indicate that the message includes updated location information.

In one embodiment, the emergency text message application 205 directs the location determination module 204 to obtain a location as soon as the user actuates the emergency text message application 205 via the user interface 207. In other words, the location determination procedure starts when the user accesses the initial menu screen for sending the emergency text message. When the distressed user pushes “send,” which may be one of the soft keys 213, the emergency text message is routed to a text-enabled Public Safety Access Point (PSAP). The emergency text message includes the location inserted therein. By way of example, a completed emergency text message 209 reading “Hold-up at convenience store located at ‘MY_LOC’—send police as soon as possible,” or “Intruder in my home located at ‘MY_LOC’, send police as soon as possible” may be selected by the user. The emergency text message application 205 then inserts the location of the portable electronic device 200 into the MY_LOC field. This location, retrieved from the location determination module 204, can be geodetic or civic.

Embodiments of the present invention can be used with a variety of text messaging protocols. For example, the emergency text message may be sent via Short Message Service (SMS) systems, Multimedia Message Service (MMS) systems, Instant Messenger (IM) systems, IM over Session Interrupt Protocol (SIP) systems, and so forth.

In one embodiment, in addition to the emergency text message application 205, other modules are also included. These additional modules may also be embedded firmware instruction sets for the processor 201. Alternatively, they may be configured in hardware. While the functionality of some of the various modules will be explained in more detail below, a brief description and identification of other modules is included here with FIG. 2.

For instance, one module that may be included is the presentation application 217. The presentation application 217 is configured, upon receipt of information from the user interface 207, to retrieve a partially completed emergency text message or a completed emergency text message from a template database 218. The template database 218, in one embodiment, is a section of memory used to store these messages. Upon retrieving the partially or fully completed emergency text message template database 218, the presentation application 217 presents the selected message on the display 215. The emergency text message application 205, or alternatively the user, may then populate any user fillable fields required to complete the message. Additionally, in one embodiment, the user may edit, add to, or delete from the predetermined segments of the message as well.

A navigation application 219 may optionally be included where partially completed emergency text messages are used. The navigation application 219 is operable with the processor 201 and responds to commands from the user interface 207 to locate and populate any user fillable fields. Upon receipt of such a command, e.g. when the user presses a key, the navigation application 219 can cause a cursor on the display 211 to move to a user fillable field, thereby allowing the user to complete the emergency text message.

A data entry application 220 may also be included where user editable partially populated emergency text messages are used. The data entry application 220 is operable with the processor 201 and responds to commands from any of the data entry keys in the user interface 207. Upon receipt of a data command, e.g. when a user presses a data entry key, the data entry application 220 populates a cursor location with data. For example, if a user has moved to a specific user fillable field, upon actuation of a data entry key the data entry application 220 can populate that particular user fillable field.

Note that data entry by data entry keys need not be the only way to populate the user fillable fields in accordance with the invention. In one embodiment, the emergency text message application 205 is able to retrieve objects stored in memory 202, such as pictures, predetermined text, audio, video, address book entries, and other types of data. In such an embodiment, the data entry application 220 may also comprise a data retrieval module 221. The data retrieval module 221, operable with the processor 201, upon receipt of a command from the emergency text message application 205, retrieves an object disposed within memory 202 of the portable electronic device 200 and inserts the object into one of the unpopulated fields. Thus, rather than entering the data in the field, a picture or other representation of the user may be entered to further assist emergency personnel arriving at the scene. While automatic data entry is an option, it can be faster to present only fully completed emergency text messages on the display. These are generally the quickest for the user to send, as no user fillable fields need to be completed.

Note that while user interface 207 in the illustrative embodiment of FIG. 2 includes physical keys on the portable electronic device 200, it will be clear to those of ordinary skill in the art having the benefit of this disclosure that the invention is not so limited. While in one embodiment keys may be used, in other embodiments voice recognition, gestures, handwriting recognition, and other equivalent data entry mechanisms may also be employed.

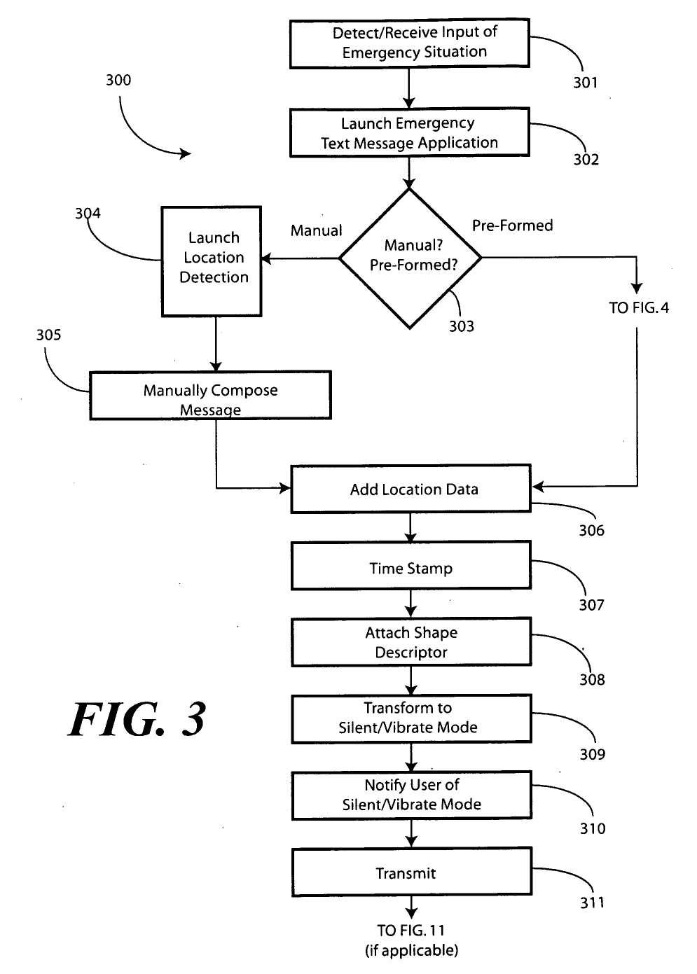

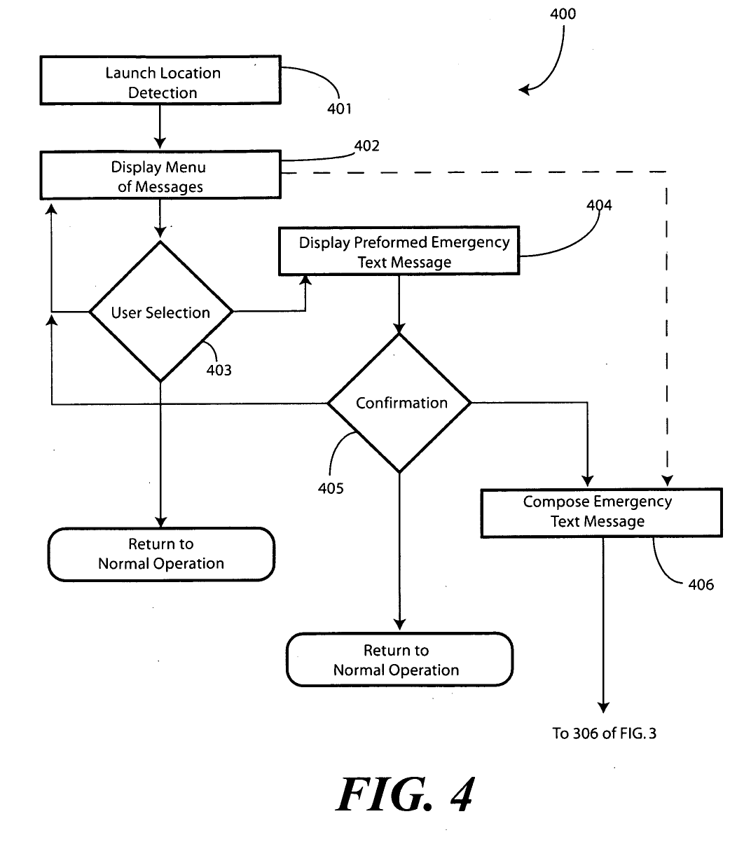

Turning now to FIG. 3, illustrated therein is one method 300 suitable for use with a portable electronic device (200) as an emergency text message application (205) in accordance with embodiments of the invention. The method 300 may be configured as firmware or embedded instructions for the processor (201) stored in the memory (202). Alternatively, it can be configured in hardware as programmable logic.

At step 301, the method 300 determines that an emergency situation is occurring. This can be determined in a variety of ways. In one embodiment, the method determines that an emergency event is occurring through user input from the user interface (207). As discussed above, the user may select a distress key or otherwise actuate the user interface (207) to alert the emergency text message application (205) that an emergency is occurring. Alternatively, a sensor within the portable electronic device (200) can detect an emergency situation. Other methods can be used as well. For example, an alarm may communicate with the portable electronic device (200) via a near field communication protocol such as Bluetooth to alert the portable electronic device (200) that an emergency is occurring. Such an alarm may be disposed within a vehicle, home, or business.

At step 302, the method 300 launches the emergency text message application (205) in response to the detection of an emergency situation. Note that the step 301 of detecting an emergency situation may be a component of the emergency text message application (205). As such, the step 302 of launching may cause the presentation of emergency text messages on the display (211) or other actions, as will be described below.

In one embodiment, the method 300 permits the user to select whether they would like to type a message or use a pre-formed message. Where this option is employed, the decision whether to manually input a message or use a preformed message is made at decision 303. Where the user elects to manually input the message, this is done at step 305. The method 300 may launch the location detection module (204) at step 304, so that the location detection module (204) may determine the appropriate location of the portable electronic device (200) to be inserted into the emergency text message.

The procedure associated with pre-formed messages is shown in FIG. 4. Turning now to FIG. 4, illustrated therein is one embodiment of a method 400 of using pre-formed messages, either partially completed or fully completed messages, in the emergency text message application (205). At step 401, method 400 may launch the location detection module (204) so that the location detection module (204) may determine an approximate location of the portable electronic device (200) to be inserted into the emergency text message.

At step 402, the method 400 presents one or more fully completed or partially completed emergency text messages on the display (211). A user may then select a pre-formed message, which is detected at decision 403. Where a processor (201) is employed to execute the method 300, the processor (201) receives the user selection corresponding to the selected emergency text message from the user interface (207) at decision 403. The selected message is then presented on the display (211) at step 404.

In one embodiment, the user may be given an opportunity to confirm the selection. As unnecessary emergency text messages can be confusing to emergency personnel, and as the user may be under an abnormal amount of stress when selecting the pre-formed message, the confirmation provides a safeguard against the transmission of unnecessary emergency messages. The user's confirmation is detected at decision 405.

At step 406, the user composes the emergency text message. Where the selected message is a fully completed emergency text message, there is no composition necessary and this step can be omitted. Further, where the emergency text message is a partially completed emergency text message that is automatically populated by the emergency text message application (205), there is no composition necessary. However, where the selected message is a partially completed emergency text message with user fillable fields, the user may compose the remainder of the message at step 406.

As noted above, in one embodiment the partially completed emergency text message comprises one or more unpopulated fields. Examples of unpopulated fields include the name of the user of the portable electronic device (200), the type of emergency occurring, the urgency level, the type of emergency personnel required, and so forth. As also noted above, these fields may be automatically populated by the emergency text message application (205).

In an optional embodiment, these unpopulated fields may be tab accessible. Further, they may be manually populated, or alternatively they may be completed when the emergency text message application (205) presents a plurality of user selectable population options for the unpopulated fields. Such user selectable population options may be presented, for example, in a pull-down menu or other graphical interface. Examples of user population options include user identification text, emergency identification text, device identification text, pictures, audio content, video content, and so forth.

Once the user has composed the message (if necessary) at step 406, the method returns to step 306 of FIG. 3. Turning now back to FIG. 3, at step 306 the method is configured to insert the location of the portable electronic device (200), attained from the location detection module (204), into the emergency text message. As noted above, the location initially inserted into the emergency text message may be one of lesser accuracy, such as a base station identifier.

Steps 307-309 set forth optional additions that may be included within the emergency text message to further assist emergency personnel responding to the emergency text message. They are not required. At step 307, the method 300 can be configured to timestamp the emergency text message. The timestamp may be the time of transmission as noted by the portable electronic device (200). Such a timestamp can be helpful as it can provide the PSAP and responding emergency personnel additional information regarding when the emergency occurred or when the emergency text message was transmitted. This information can be especially helpful where the emergency text message is delayed within the network in route to the PSAP.

At step 308, the method 300 can attach a shape descriptor to the emergency text message. A shape descriptor can provide information regarding the uncertainty dimensions associated with a location approximation. For example, one embodiment of a shape descriptor might be a geographic representation, such as a circle, having a radius indicating an uncertainty probability of the portable electronic device's location. The shape descriptor may present a circle within which there is a 95% probability of locating the portable electronic device (200). Shape descriptors are known in the art, as examples are given in the 3GPP standard specification 3GPP23.032, Universal Geographical Area Description (GAD) 3GPP. This specification provides standard definitions of a variety of shapes. In one embodiment, the shape descriptor comprises a representation of uncertainty and dimensions associated with a user location.

At step 309, the method 300 can be configured to transform the portable electronic device (200) to either a silent mode or a vibration mode. This option is useful where the user of the portable electronic device (200) is proximately located with a threat, such as a home invader or armed bandit. By transforming the portable electronic device (200) from a mode with audible ring tones or other alerts into a non-audible mode, there is a reduced probability that the threat will be alerted to any response messages.

In one embodiment, the method 300 may transform the portable electronic device (200) into the non-audible mode when the message is sent. In another embodiment, the method 300 may transform the portable electronic device (200) into the non-audible mode as soon as the emergency text message application (205) is launched. In one embodiment, the method 300 is configured to automatically transform the portable electronic device (200) to one of a silent mode or a vibration mode upon presenting the retrieved emergency text message on the display. Where the method 300 transforms the portable electronic device to a non-audible mode, the method 300 may optionally present a notification on the display (211) that the transformation has occurred at step 310.

At step 311, the emergency text message is transmitted to an emergency call services center via an emergency call services number, such as 911, E911, SOS, 112, an emergency services URI, and so forth. In one embodiment, the emergency text message will then be automatically routed to the correct PSAP by a messaging server using the equivalent of a selective router function for text messages. The PSAP responder can then see the emergency text message. The PSAP responder can optionally respond via text to the user, or dispatch help.

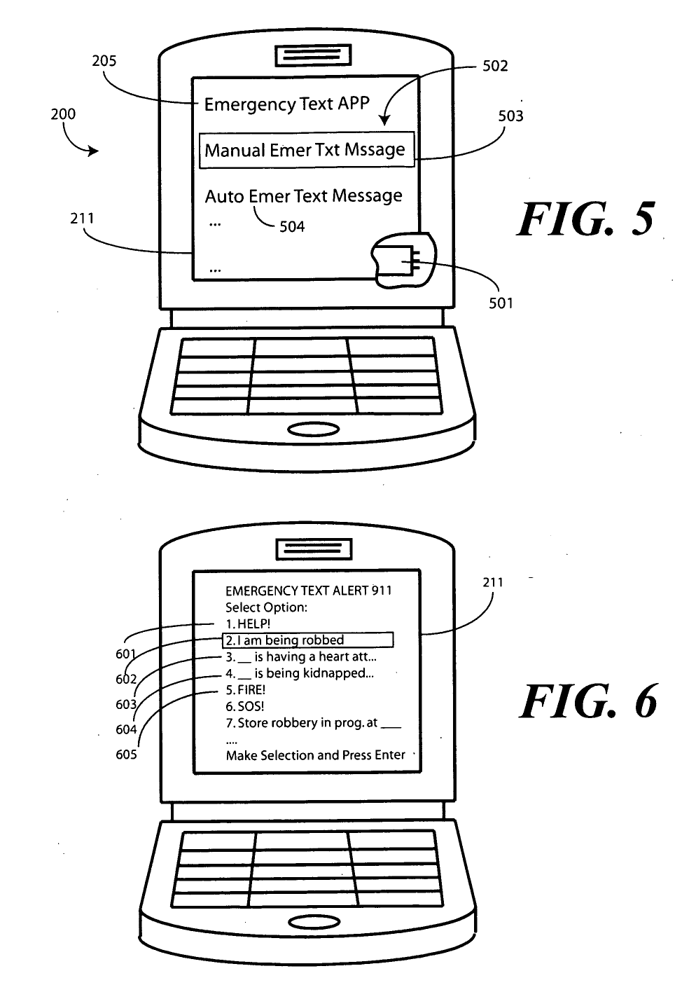

Turning now to FIG. 5, illustrated therein is one exemplary screenshot of the portable electronic device 200 with the emergency text message application 205 actuated. As noted above, this actuation can be in response to user input or in response to a detector 501 within the portable electronic device 200 detecting an emergency situation. Upon detecting the emergency, in one embodiment the portable electronic device 200 presents a menu 502 of options for creating emergency text messages on the display 211. In one embodiment, the emergency text message application 205 initially gives the user a choice of using a partially or fully completed message 504, or alternatively entering a message 503 manually.

Turning now to FIG. 6, illustrated therein is a screenshot of one exemplary list of partially or completed messages presented on the display 211. In this illustrative embodiment, the list of messages includes both partially completed messages and fully completed messages. For example, emergency text messages 601, 602, and 605 are fully completed emergency text messages, while emergency text messages 603, 604 are partially completed emergency text messages. Some applications may list only fully completed emergency text messages, while some applications will list only partially completed emergency text messages. Embodiments of the present invention provide the designer to use one, the other, or combinations thereof.

In the illustrative view of FIG. 6, the user has selected a fully completed emergency text message 602. Specifically, the user has selected a message saying, “I am being robbed!” by highlighting fully completed emergency text message 602. The user selects this highlighted fully completed emergency text message 602 with the user interface (207).

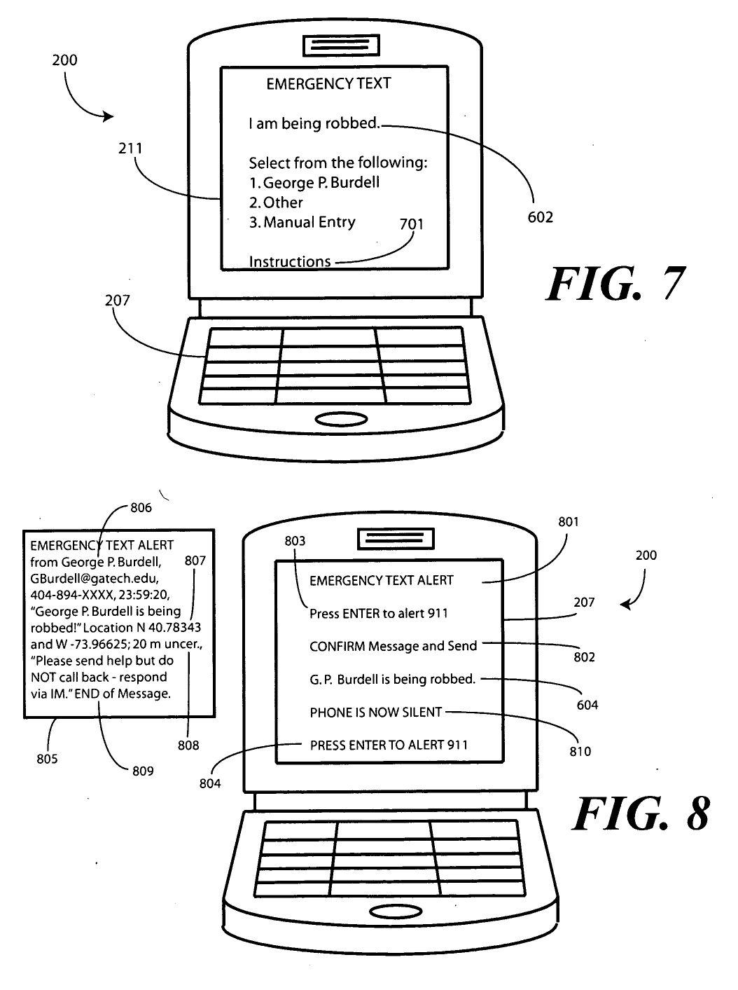

Turning now to FIG. 7, illustrated therein is an exemplary screenshot of the portable electronic device 200 having a fully completed emergency text message 602 presented on the display 211. If the message were a partially completed emergency text message, the partially completed emergency text message may include one or more tab accessible user fillable fields. The tab accessible user fillable field could be interlaced among partially populated components. Where user fillable fields are used, the emergency text message application (205) can be configured to receive user input from the user interface 207 to complete the partially completed emergency text message by populating the user fillable field with user input. Where the emergency text message application (205) is configured to automatically populate the empty field, the message may be presented as a completed message with the empty field already filled in.

When a user editable partially completed emergency text message is initially presented on the display 211, the tab accessible user fillable field may be unpopulated. A cursor can indicate which of the tab accessible user fillable fields is available for editing. The user can move between the tab accessible user fillable fields with the user interface 207. Data entry keys may be used to populate the various tab accessible user fillable fields. In one embodiment, the data entry keys may also be used to edit the partially populated segments as well.

The user may populate the tab accessible user fillable fields in a variety of ways. In one embodiment, the user may populate the user tab accessible user fillable field with text, such as “George P. Burdell.” Alternatively, the emergency text message application (205) can be configured to present a plurality of user selectable population options for the unpopulated field, such as through a pull-down menu. This information can include user identification text, device identification text, pictures, audio content, or video content.

In some applications, the user may populate the tab accessible user fillable field with other information, including preformed text segments, pictures or image files, audio content or sound files, or video content or video files. The emergency text message application (205) may also be configured to present instructional information 701 for sending the fully completed emergency text message 602 on the display 211 as well.

Turning now to FIG. 8, illustrated therein is an illustrative screen shot of an emergency confirmation screen 801 that can be presented on the display 211 after an emergency text message has been completed. In one embodiment, a confirmation message indicator 802 is presented so that the user can confirm the proper selection and/or proper entry of data in to the emergency text message. Further, an action indicator 803 can be presented alerting the user what will happen when the message is sent. An instructional message 804 can also be presented. The instructional message 804 can direct the user how to transmit the emergency text message. Such an instructional message 804 can be of assistance to a user under stress.

In one embodiment, as noted above, other information is sent in addition to the text of the emergency text message. For example, the emergency text message application (205) can insert location information obtained from the location detection module (204). Emergency text message 805 illustrates one embodiment of such a message. In the emergency text message 805, in addition to the emergency text, the emergency text message application (205) has included a user identifier 806 that includes the user's name, e-mail address, and mobile telephone number. Such information can be obtained from the user profile stored in the memory (202) of the portable electronic device 200 or from an address book application.

The emergency text message application (205) has also inserted location information 807, which can be obtained from the location detection module (204) as described above. For example, this location information can be any of a base station identifier, base station location, triangulation information, or coordinates received from GPS satellites. An error estimate 808 may be included with the location information 807.

In one embodiment the emergency text message application (205) may also include additional distress text 809. For example, the additional distress text 809 shown in the illustrative embodiment of FIG. 8 reads, “Please send help but do NOT call back; Respond via IM.” This form of additional distress text 809 would be appropriate where there is a high probability that the user is facing a threat, such as in a robbery. Consequently, it may be appended to emergency text messages indicating robberies and like emergencies. However, this type of additional distress text 809 may not be appropriate for other emergency situations, such as fires. In emergency text messages configured for such emergencies, the additional distress text 809 may be omitted or changed.

In one embodiment of the invention, the emergency text message application (205) can be configured with an alert disabler configured to automatically transform the portable electronic device 200 to one of a silent mode or a vibration mode upon determining an emergency text message has been transmitted to an emergency services call number. The alert disabler can also be configured to automatically transform the portable electronic device 200 to one of a silent mode or a vibration mode upon actuation of the emergency text message application (205). Where this feature is used, the emergency text message application (205) can be configured to present a notification 810 on the display that the portable electronic device 200 has been thusly transformed. Such an illustrative notification 810 is shown in FIG. 8.

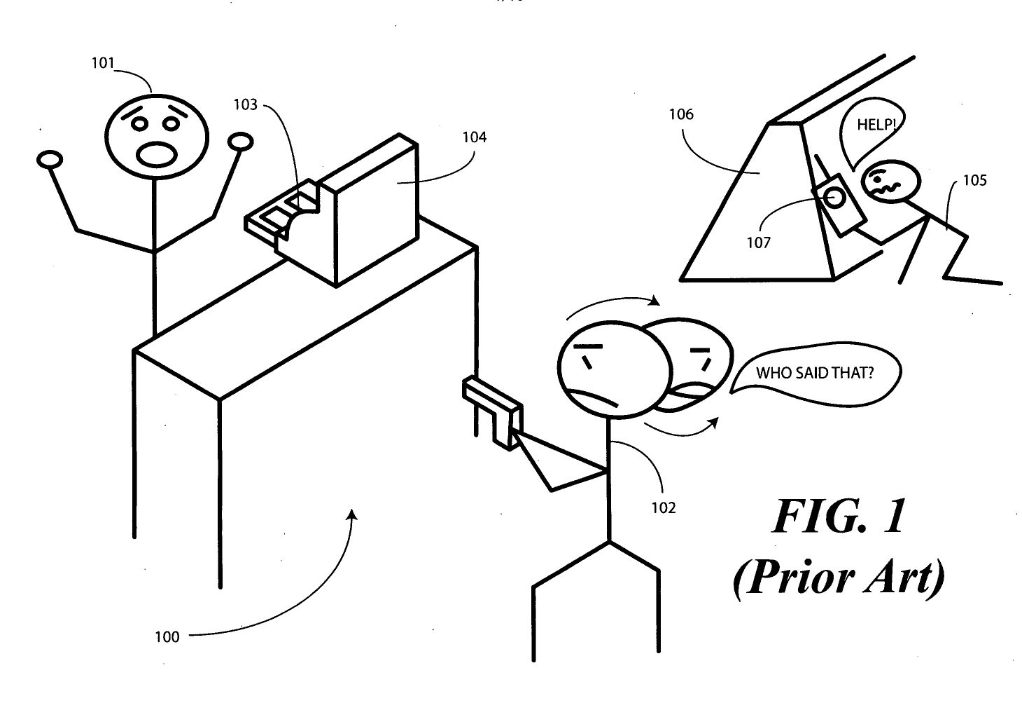

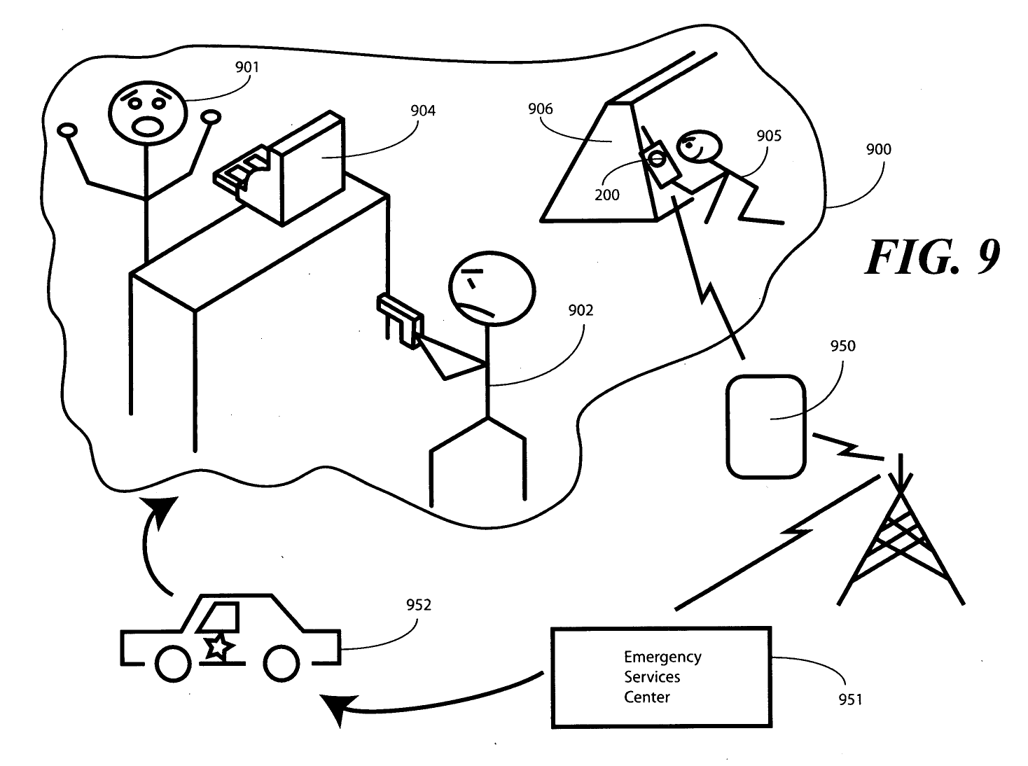

Turning now to FIG. 9, illustrated therein is an emergency situation 900 similar to that shown in FIG. 1. However, in FIG. 9, the store patron 905 is equipped with a portable electronic device 200 configured in accordance with embodiments of the invention.

In the illustrative embodiment of FIG. 9, a store clerk 901 is being held at gunpoint by a crook 902 who is attempting to take money from the cash register 904. The store patron 905 is undetected by the crook 902, as he is hiding between aisles 906 of goods. The store patron 905 has a portable electronic device 200 in accordance with embodiments of the invention, which in this case is a mobile telephone.

In the scenario of FIG. 9, the store patron 905 cannot speak without alerting the crook 902 of the store patron's presence. As such, the store patron 905 accesses the emergency text message application (205) as described above. In this particular application, the emergency text message application (205) is equipped with a list of fully completed emergency text messages. The store patron 905 is able to access a preformed emergency text message. In this case, the store patron 905 accesses a fully completed emergency text message having the text, “I am being robbed.”

Upon selection, the emergency text message application (205) pulls location information from the location detection module (204). The emergency text message application (205) then inserts the location information into the emergency text message 950 that is to be sent. As the emergency situation 900 of FIG. 9 is one where the threat is proximately located with the store patron 905, the emergency text message application (205) will also insert additional distress text (809) that states, “Send help immediately but do not call back. Threat present.”

Also upon selection of the preformed emergency text message, the emergency text message application (205) will take the store patron 905 to the emergency confirmation screen (801). At this screen, the store patron 905 will be informed that pressing a particular key on the user interface (207) will actually transmit the emergency text message 950 to the appropriate emergency services personnel through an emergency services call number, such as 911 or SOS. The emergency services call number will depend upon what regional authorities use as an appropriate emergency services call number. The emergency confirmation screen (801) may also tell the store patron 905 that his location will be included in the emergency text message 950.

The emergency text message 950 is then sent to the emergency services center 951. This transmission can be through any of a variety of methods, including short message services, multimedia message services, instant messaging, messaging over session interrupt protocol, and so forth. Emergency personnel 952 can then be dispatched to render assistance.

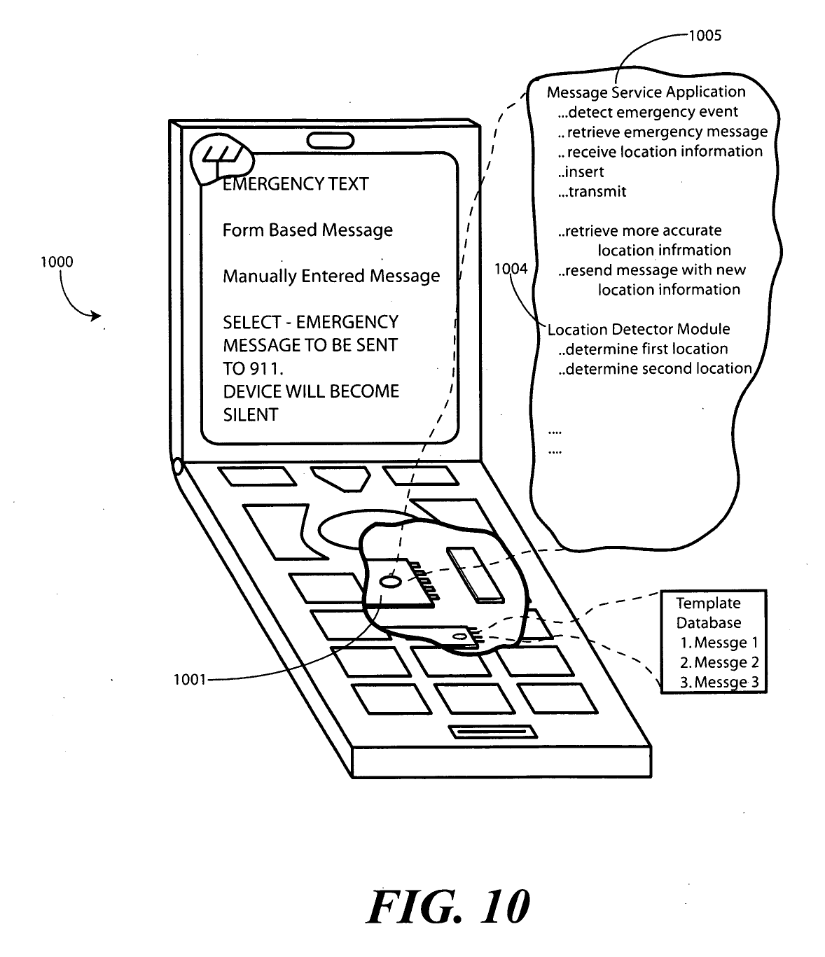

Turning now to FIG. 10, illustrated therein is one embodiment of an electronic communication device 1000 equipped with an enhanced location determination module 1004. In the embodiment of FIG. 10, the emergency text message application 1005 is configured to send repeated emergency text messages as improved location information is determined. A first emergency text message can be sent quickly, using an imprecise location obtained from the location determination module 1004, such as a last used base station identifier. The emergency text message application 1005 can then be configured to automatically retransmit an updated version of the emergency text message when a more precise location obtained, such as from GPS satellites. In one embodiment, the header of the emergency text message is automatically changed to inform the emergency services personnel that the message is an update with improved location data and not simply a repeat transmission.

In the embodiment of FIG. 10, the location determination module 1004 is capable of attaining at least a first location determination of the electronic communication device and a second location determination of the electronic communication device, wherein the second location determination is more accurate than the first location determination. The first location determination may be a triangulation from communicating base stations, while the second location determination may be coordinates received from GPS satellites.

In such an embodiment, the emergency text message application 1005 is configured to control the processor 1001 to transmit a first emergency text message to an emergency services call number with the first location determination attached. When the location determination module 1004 attains the second location determination, the emergency text message application 1005 is configured to transmit a second emergency text message to the emergency services call number with the second location determination attached.

Note that in one embodiment, both the first location determination and the second location determination may each refer to the same approximate location of the electronic communication device. The second location determination will just be a more accurate representation of that location. In other situations, the first location determination and second location determination may refer to different locations, as the user of the electronic communication device 1000 may be on the move. In either or both cases, the emergency text message application 1005 may be configured to attach an indicator of uncertainty to the emergency text message to alert the emergency services personnel to the relative accuracy of the location determination. For example, a shape descriptor can be attached to the emergency text message. In other embodiments, the first and second location determinations may be in different formats. For example, the first location could be in civic address format, with no shape descriptor, and the updated location could be in a more precise, geodetic representation with a shape descriptor attached.

In one embodiment, upon determining a more accurate location of the electronic communication device 1000, the emergency text message application 1005 can be configured to replace the location of the completed emergency text message with the more accurate location and retransmit the completed emergency text message to the emergency services call number. Further, the emergency text message application 1005 can be configured to cause a header of the second emergency text message to indicate the second emergency text message has an updated location determination of the electronic communication device.

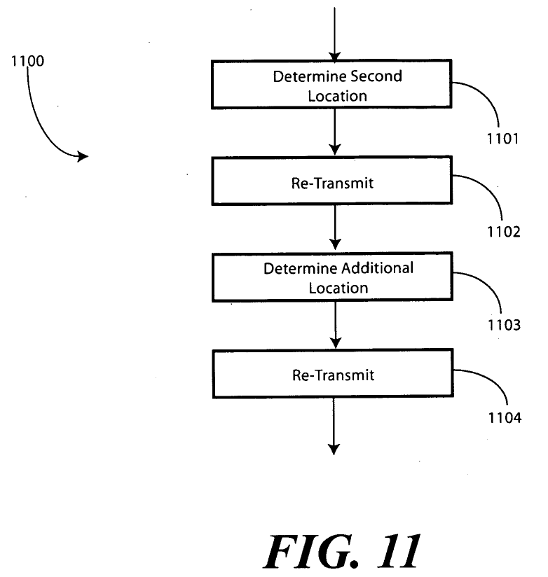

Turning now to FIG. 11, illustrated therein is a method 1100, which may be configured as firmware or hardware, for transmitting subsequent emergency text messages with updated location determination information. The method 1100 can be used in conjunction with the method of FIG. 3. For example, step 1101 of method 1100 can follow step 311 of FIG. 3.

At step 1101, the location determination module (1004) determines a more accurate measurement of location. Where the first location determination was a base station identifier, the second, more accurate location determination may be a triangulated base station location or location data from a satellite-positioning receiver disposed in the electronic communication device (1000). At step 1102, the emergency text message application (1005) is configured to control the processor (1001) to transmit a subsequent emergency text message comprising the subsequent location determination.

This process can repeat as additional or better location determination is obtained. For example, a first emergency text message may be sent with course location information referring to a first location. A second message may be sent with more accurate location information that refers to the first location. The user may then move. A third message may be sent with course location information referring to the second location, as indicated by steps 1103, 1104. A fourth message may then be sent with more accurate location information referring to the second location, and so forth.

Turning now to FIG. 12, illustrated therein are some of the modes through which location information can be obtained. The electronic communication device 1000 of FIG. 12 can obtain a first location determination that is an identifier 1201 of a last used base station 1202. The electronic communication device 1000 may then transmit a first emergency text message 1203 having that identifier 1201 attached thereto.

Later, the electronic communication device 1000 can attain a more accurate location determination. This could be triangulation 1204 from base stations, or information 1205 from GPS satellites. Upon making this second determination, the electronic communication device 1000 can send a second emergency text message 1206 with the additional, updated location information. It is also expected that the follow-up messages could include location updates resulting from movement of the user.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims.

What is claimed is:

1. A electronic communication device configured to alert emergency services to a location of an emergency situation, the electronic communication device comprising:
a processor;
a location determination circuit operable with the processor, wherein the location determination circuit is capable of attaining at least a first location determination of the electronic communication device and a second location determination of the electronic communication device, wherein the second location determination is more accurate than the first location determination; and
an emergency text message application, operable with the processor, and configured to control the processor:
upon detecting the emergency situation, to transmit a first emergency text message to an emergency services call number, the first emergency text message comprising the first location determination; and
upon the location determination circuit attaining the second location determination, to transmit a second emergency text message to the emergency services call number, the second emergency text message comprising the second location determination.

2. The electronic communication device of claim 1, wherein the first location determination and the second location determination each refer to one approximate location of the electronic communication device.

3. The electronic communication device of claim 1, wherein the emergency text message application is further configured to cause a header of the second emergency text message to indicate the second emergency text message has an updated location determination of the electronic communication device.

4. The electronic communication device of claim 1, wherein the location determination circuit is capable of determining a subsequent location determination of the electronic communication device, the subsequent location determination being more accurate than the second location determination, wherein the emergency text message application is configured to control the processor to transmit a subsequent emergency text message comprising the subsequent location determination.

5. The electronic communication device of claim 1, wherein the emergency text message application is further configured to add predetermined additional emergency text to the one of the first emergency text message, the second emergency text message, or combinations thereof.

6. The electronic communication device of claim 1, wherein the second location determination comprises one of a triangulated base station location or location data from a satellite-positioning receiver of the electronic communication device.

7. The electronic communication device of claim 1, wherein the emergency text message application is configured to detect the emergency event by receiving a user emergency event input from a user interface.

8. The electronic communication device of claim 1, wherein the emergency text message application is further configured to timestamp the completed emergency text message.

9. The electronic communication device of claim 1, wherein the completed emergency text message is further configured to attach a shape descriptor to the completed emergency text message, wherein the shape descriptor comprises a representation of uncertainty and dimensions associated with a user location.

10. The electronic communication device of claim 1, wherein the emergency text message application is further configured to automatically transform the electronic communication device to one of a silent mode or a vibration mode.

11. A method of transmitting an emergency text message from an electronic communication device having a processor, memory, a communication circuit, and a location determination circuit operable with the processor and configured to determine a location of the electronic communication device, the method comprising:
detecting an emergency situation;
obtaining a first location determination of the electronic communication device with the location determination circuit, the first location determination having a first accuracy associated therewith;
inserting the first location determination into a first emergency text message;
transmitting a first emergency text message through the communication circuit;
determining a second location determination of the electronic communication device with the location determination circuit, the second location determination having a second accuracy associated therewith;
inserting the second location determination into the first emergency text message to form a second emergency text message; and
transmitting the second emergency text message through the communication circuit.

12. The method of claim 11, wherein the second accuracy is more accurate than the first accuracy.

13. The method of claim 11, wherein the detecting the emergency situation comprises receiving user input from a user interface, receiving an emergency signal from a detector, or combinations thereof.

14. The method of claim 11, further comprising:
determining a third location determination of the electronic communication device with the location determination circuit;
inserting the third location determination into the second emergency text message to form a third emergency text message; and
transmitting the third emergency text message through the communication circuit.

15. The method of claim 11, further comprising transforming the electronic communication device to one of a silent mode or a vibration mode.

16. The method of claim 11, further comprising changing a header of the second emergency text message to indicate the second emergency text message has an updated location determination therein.

17. The method of claim 11, further comprising applying a timestamp any of the first emergency text message, the second emergency text message, or combinations thereof.

18. The method of claim 11, further comprising attaching a shape descriptor to any of the first emergency text message, the second emergency text message, or combinations thereof.

19. The method of claim 11, wherein the first location determination and the second location determination refer to different locations of the electronic communication device and have substantially the same accuracy.

20. The method of claim 11, further comprising attaching an indicator of uncertainty to any of the first emergency text message, the second emergency text message, or combinations thereof.
